(19) United States
(12) Patent Application Publication
(10) Pub. No.: US 2023/0370363 A1
(43) Pub. Date: Nov. 16, 2023

(54) DYNAMIC TUNNEL SPLIT/MERGE USING CENTRALIZED CONTROLLER

(71) Applicant: AT&T Intellectual Property I, L.P., Atlanta, GA (US)

(72) Inventors: Narayan Padi, Cedar Knolls, NJ (US); Gagan Choudhury, Jackson, NJ (US); Alvin C. Goddard, Kendall Park, NJ (US); Harpreet Ahluwalia, Holmdel, NJ (US); Aswatnarayan Raghuram, Morganville, NJ (US)

(73) Assignee: AT&T Intellectual Property I, L.P., Atlanta, GA (US)

(21) Appl. No.: 17/744,274

(22) Filed: May 13, 2022

(51) Int. Cl. H04L 45/247

(52) U.S. Cl. CPC H04L 45/247

(57) ABSTRACT

Aspects of the subject disclosure may include, for example, obtaining node data identifying for a network a source node, a destination node and a plurality of other nodes; obtaining reference path data identifying a reference path from the source node to the destination node; obtaining alternate path data identifying a plurality of alternate paths from the source node to the destination node, setting for the reference path a possible split threshold identifying a traffic bandwidth which can trigger a re-direction of traffic from the reference path; determining whether a current traffic flow on the reference path meets the possible split threshold, resulting in a first determination; responsive to the first determination, obtaining, subsequent to the setting for the reference path of the possible split threshold, current alternate path data for each of the plurality of alternate paths, wherein the current alternate path data comprises for each of the alternate paths a respective current alternate path bandwidth availability; responsive to the obtaining of the current alternate path data, determining whether a particular one of the plurality of alternate paths can support carrying of at least some of the current traffic flow on the reference path, resulting in a second determination, wherein the second determination is based at least in part upon the current alternate path bandwidth availability of each of the plurality of alternate paths; and responsive to the second determination, re-directing a portion of the current traffic flow from the reference path to the particular one of the alterative paths. Other embodiments are disclosed.

### FIELD OF THE DISCLOSURE

The subject disclosure relates to dynamic tunnel split/merge using a centralized controller.

### BACKGROUND

Some tunnels in MPLS (Multiprotocol Label Switching) networks with TE (Traffic Engineering) may carry large amounts of traffic on a single tunnel. As traffic further increases, the signaled bandwidth of such tunnels grows such that putting such tunnels on a bandwidth-constrained shortest path may not be possible (e.g., due to the inability to find capacity for a large tunnel, which could lead to traffic loss). The traffic loss may occur even in situations where the overall network has sufficient capacity, but a few tunnels get very large.

One conventional approach used by network engineers to address the above issues is to study the network behavior and then to manually set-up additional tunnels between the same source-destination pairs where tunnel traffic is expected to grow. Further, each router is locally configured with upper and lower thresholds. The pre-created additional tunnels may use these thresholds to be activated when the traffic on a tunnel breaches the respective threshold.

In another conventional approach, tunnels may be split or merged automatically (using static thresholds) by the routers depending on tunnel size that is known to the routers at the head-ends of tunnels.

Under both of the above-described conventional approaches, the split/merge threshold parameters are static and are not based on the global traffic/capacity view of the entire network. As a result, sometimes a split/merge decision may be made even though the network condition may not warrant it. Too many unnecessary splits may lead to exceeding the limit on number of parallel tunnels and require extra computations. Alternatively, not enough splits or premature merges may lead to less optimal routing. In addition, the first conventional approach described above (manual setup of additional tunnels) has the further disadvantage that it can take extra time and may be error prone.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communication network in accordance with various aspects described herein.

FIG. 2A is a block diagram illustrating an example, non-limiting embodiment of a system (which can function fully or partially within the communication network of FIG. 1) in accordance with various aspects described herein.

FIG. 2B is a block diagram illustrating an example, non-limiting embodiment of a system (which can function fully or partially within the communication network of FIG. 1) in accordance with various aspects described herein.

FIG. 2C depicts an illustrative embodiment of a method in accordance with various aspects described herein.

FIG. 2D depicts an illustrative embodiment of a method in accordance with various aspects described herein.

FIG. 2E depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for dynamic tunnel split/merge using a centralized controller. One specific example uses a centralized Software Defined Network (SDN) controller. Other embodiments are described in the subject disclosure.

One or more aspects of the subject disclosure include a mechanism that can provide for: 1) The ability to route traffic efficiently and to handle traffic growth in large service provider networks; 2) Automated intelligent optimal bin packing of traffic; and/or 3) Dynamic adjustment of traffic flows based upon network capacity and traffic. In one example, implementation of the above can be based upon a global optimization study by an SDN controller algorithm. In another example, the SDN controller algorithm can operate on (e.g., receive, process, and/or send) data that is not available to one or more of the individual distributed network nodes (e.g., routers)).

In various embodiments, for each tunnel, the centralized algorithm can set a “possible split threshold” and a “possible merge threshold” (e.g., wherein the latter is smaller than the former to provide some hysteresis effect). In one specific example, these parameters (thresholds) can be the same for all tunnels. In another specific example, these parameters (thresholds) can be tunnel specific. In operation, a centralized SDN controller can monitor the signaled bandwidth of each tunnel and the amount of bandwidth reserved for each priority class (traffic priority class) on all links of the network in real-time. Whenever for any tunnel (or group of tunnels), the traffic goes above the “possible split threshold” or the traffic goes below the “possible merge threshold”, the centralized SDN controller algorithm can perform an optimization analysis (e.g., in real-time) to determine if there would be a benefit to splitting or merging. This optimization analysis can be conducted based upon global knowledge of network state at that time and (in one example) is available only to the centralized controller and not to individual distributed routers. If the optimization analysis finds a benefit to splitting or merging, then the splitting or merging is performed.

One or more aspects of the subject disclosure include a device comprising: a processing system including a processor; and a memory that stores executable instructions that, when executed by the processing system, facilitate performance of operations, the operations comprising: obtaining node data identifying a source node of a network and a destination node of the network, wherein the network comprises the source node, the destination node, and a plurality of other nodes; obtaining reference path data identifying a reference path from the source node to the destination node; obtaining alternate path data identifying a plurality of alternate paths from the source node to the destination node, wherein each of the plurality of alternate paths is different from the reference path; setting for the reference path a possible split threshold, the possible split threshold identifying a traffic bandwidth which can trigger a re-direction of traffic from the reference path; determining whether a current traffic flow on the reference path meets the possible split threshold, resulting in a first determination; responsive to the first determination being that the current traffic flow on the reference path meets the possible split threshold, obtaining, subsequent to the setting for the reference path of the possible split threshold, current alternate path data for each of the plurality of alternate paths, wherein the current alternate path data comprises for each of the plurality of alternate paths a respective current alternate path bandwidth availability; responsive to the obtaining of the current alternate path data for each of the plurality of alternate paths, determining whether a particular one of the plurality of alternate paths can support carrying of at least some of the current traffic flow on the reference path, resulting in a second determination, wherein the second determination is based at least in part upon the current alternate path bandwidth availability of each of the plurality of alternate paths; and responsive to the second determination being that the particular one of the plurality of alternate paths can support the carrying of at least some of the current traffic flow on the reference path, re-directing a portion of the current traffic flow from the reference path to the particular one of the alterative paths.

One or more aspects of the subject disclosure include a non-transitory machine-readable medium comprising executable instructions that, when executed by a processing system including a processor, facilitate performance of operations, the operations comprising: obtaining network data indicative of a network comprising a source router, a destination router, and a plurality of other routers; obtaining reference path data indicative of a reference path from the source router to the destination router; setting for the reference path a possible split threshold, the possible split threshold identifying a traffic bandwidth which can trigger a directing of traffic from the reference path to another path; obtaining, subsequent to the setting for the reference path of the possible split threshold, alternate path data indicative of a plurality of alternate paths from the source router to the destination router, wherein each of the plurality of alternate paths is different from the reference path, wherein the alternate path data identifies for each of the plurality of alternate paths respective current alternate path bandwidth capacity, and wherein the alternate path data identifies for each of the plurality of alternate paths respective current alternative path latency; determining whether a current traffic flow that is being carried on the reference path is at or above the possible split threshold, resulting in a first determination; responsive to the first determination being that the current traffic flow that is being carried on the reference path is at or above the possible split threshold, determining whether two or more particular ones of the plurality of alternate paths can support carrying some of the current traffic flow that is being carried on the reference path, resulting in a second determination, wherein the second determination is based at least in part upon the current alternate path bandwidth capacity for each alternate path; responsive to the second determination being that the two or more particular ones of the plurality of alternate paths can support carrying of some of the current traffic flow that is being carried on the reference path, determining which of the two or more particular ones of the plurality of alternate paths that can support carrying of some of the current traffic flow that is being carried on the reference path has a lower latency, resulting in a third determination, wherein the third determination is based at least in part upon the current alternate path bandwidth latency for each alternate path; and responsive to the third determination as to which of the two or more particular ones of the plurality of alternate paths that can support carrying of some of the current traffic flow that is being carried on the reference path has the lower latency, directing the some of the current traffic flow from the reference path to the particular one of the alternate paths that has the lower latency.

One or more aspects of the subject disclosure include a method comprising: obtaining, by a processing system including a processor, network data indicative of an Internet Protocol (IP) network comprising a source router, a destination router, and a plurality of other routers; obtaining, by the processing system, first path data indicative of a first path from the source router to the destination router; setting, by the processing system, for the first path a possible split threshold, the possible split threshold identifying a traffic bandwidth which can trigger a re-directing of a portion of traffic from the first path to one or more other paths; obtaining by the processing system, subsequent to the setting for the first path of the possible split threshold, alternate path data indicative of a plurality of alternate paths from the source router to the destination router, wherein each of the plurality of alternate paths is different from the first path, wherein the alternate path data identifies for each of the plurality of alternate paths respective current alternate path bandwidth capacity, and wherein the alternate path data identifies for each of the plurality of alternate paths respective current alternate path latency; determining, by the processing system, whether a current traffic flow that is being carried via the first path is at or above the possible split threshold; responsive to determining that the current traffic flow is at or above the possible split threshold, determining by the processing system whether each of three or more candidate paths of the plurality of alternate paths can support carrying of at least some of the current traffic flow that is being carried on the first path, wherein the determining whether each of the three or more candidate paths can support carrying of at least some of the current traffic flow that is being carried on the first path is based at least in part upon the current alternate path bandwidth capacity for each alternate path; responsive to determining that each of the three or more candidate paths can support carrying of at least some of the current traffic flow that is being carried on the first path, determining by the processing system a subset of the three or more candidate paths, wherein the subset comprises at least two paths, and wherein each of the at least two paths has a latency less than that of at least one of the other ones of the three or more candidate paths; and responsive to the determining the subset, directing by the processing system a first portion of the current traffic flow from the first path to a first one of the paths of the subset and directing a second portion of the current traffic flow from the first path to a second one of the paths of the subset.

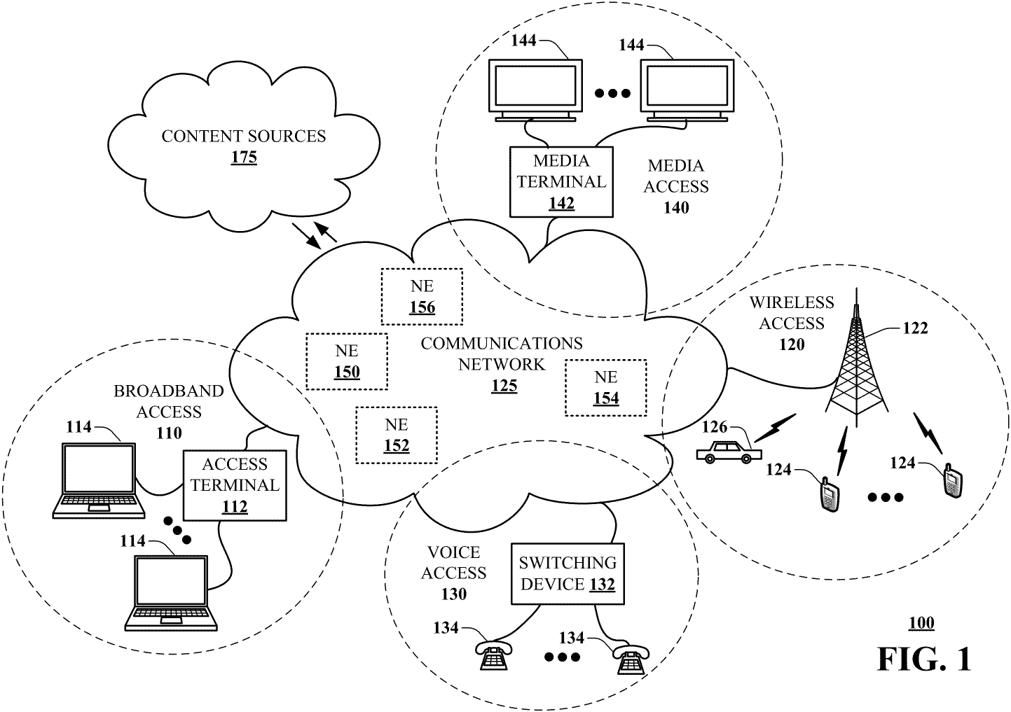

Referring now to FIG. 1, a block diagram is shown illustrating an example, non-limiting embodiment of a system 100 in accordance with various aspects described herein. For example, system 100 can facilitate in whole or in part dynamic tunnel splitting/merging using a centralized controller. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

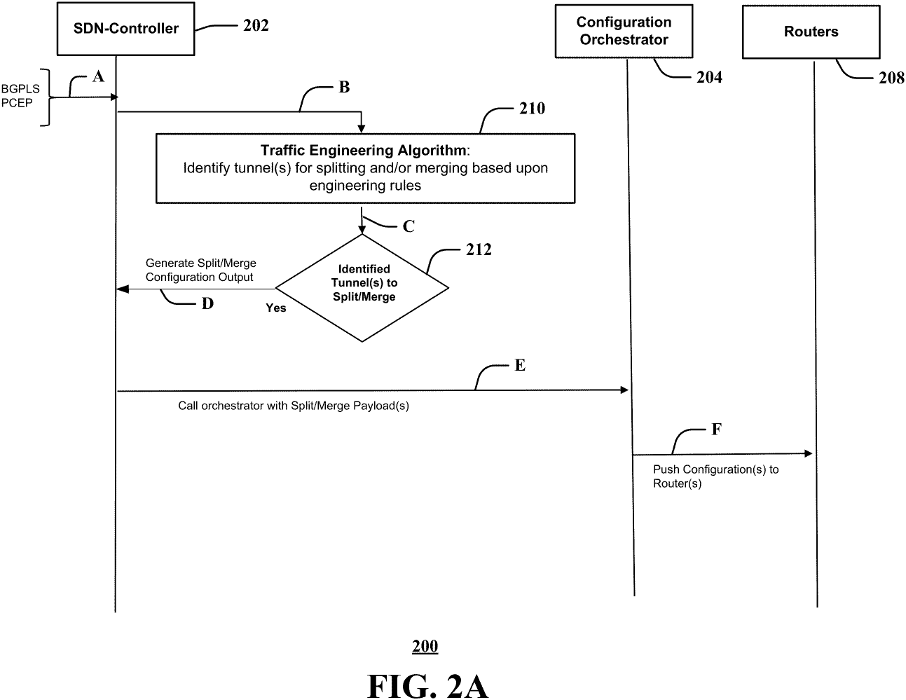

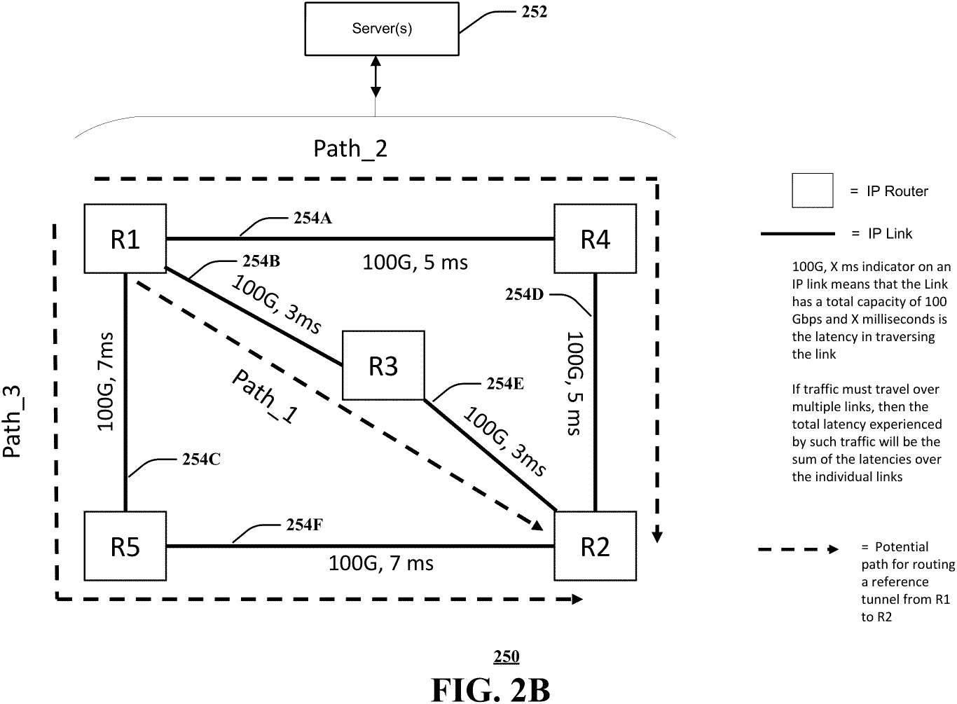

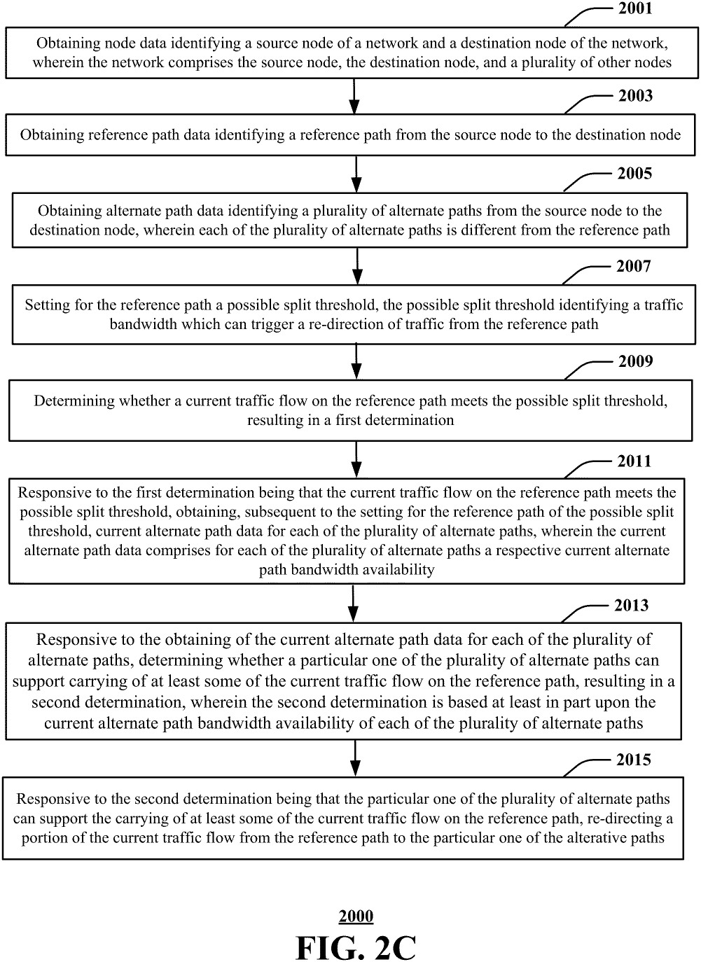

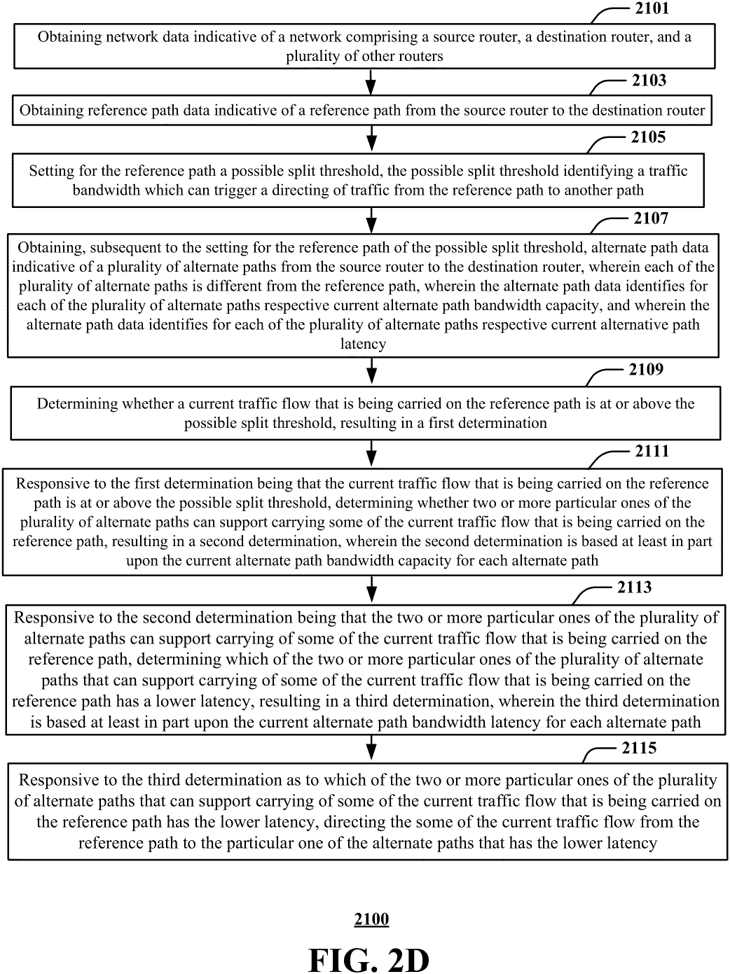

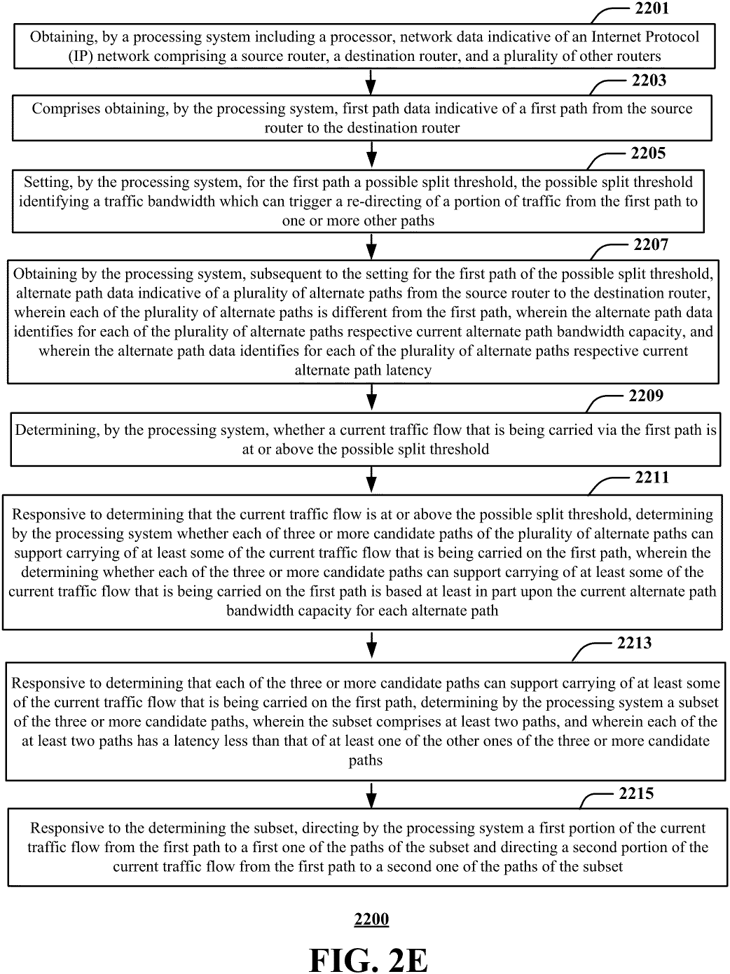

Referring now to FIG. 2A, this is a block diagram (of a high-level flow for tunnel split/merge) illustrating an example, non-limiting embodiment of a system 200 (which can function fully or partially within the communication network of FIG. 1) in accordance with various aspects described herein. As seen in this figure, SDN-Controller 202 can receive (see arrow “A”) data from BGP-LS (Border Gateway protocol - Link State) and/or PCEP (Path Computation Element Protocol). In various examples, the SDN-Controller has BGP and PCEP peering with the routers that participate in centralized optimization (the topology (BGP-LS) and tunnel (PCEP) data can be available in real-time to the algorithm making the split/merge decisions). Further, the BGPLS and/or PCEP data that is received can be applied (see arrow “B”) to Traffic Engineering Algorithm 210. This Traffic Engineering Algorithm 210 can function to identify tunnel(s) for splitting and/or merging based upon engineering rules. In one example, the Traffic Engineering Algorithm 210 can be implemented by SDN-Controller 202. In another example, the Traffic Engineering Algorithm 210 can be implemented by an element other than SDN-Controller 202. Further still, it is seen that a determination 212 can be made as to whether there are identified tunnel(s) to split/merge. In the case that there are identified tunnel(s) to split/merge (“Yes”) then a Split/Merge Configuration Output is generated (see arrow “D”).

Still referring to FIG. 2A, it is seen that the SDN-Controller 202 can call Configuration Orchestrator 204 with split/merge payloads (see arrow “E”). The split/merge payloads can be based upon the Split/Merge Configuration Output. Further, the Configuration Orchestrator 204 can push configuration(s) to Routers 208 (see arrow “F”). The configurations that are pushed to the Routers 208 can be based upon the split/merge payload(s).

Referring now to FIG. 2B, this is a block diagram illustrating an example, non-limiting embodiment of a system 250 (which can function fully or partially within the communication network of FIG. 1) in accordance with various aspects described herein. As seen in this example, there is a network comprising five IP routers (R1, R2, R3, R4, R5). Further, each of the routers is configured for bi-directional communication with Server(s) 252. The Server(s) 252 can communicate with the routers R1, R2, R3, R4, R5 such as to receive data from the routers, send data to the routers, and carry out various network monitoring, configuration and/or routing functions described herein.

Still referring to FIG. 2B, it is seen that router R1 is connected to router R4 by IP link 254A, that that router R1 is connected to router R3 by IP link 254B, that router R1 is connected to router R5 by IP link 254C, that router R4 is connected to router R2 by IP link 254D, that router R3 is connected to router R2 by IP link 254E, and that router R5 is connected to router R2 by IP link 254F. In this drawing, each of these IP links is shown as a solid line. Further, in this drawing, a respective bandwidth and latency for each of these IP links is shown as 100G, X ms (these notations being indicators meaning that the respective IP link has a total capacity of 100 Gbps and X milliseconds is the latency in traversing the link (if traffic must travel over multiple links, then the total latency experienced by such traffic will be the sum of the latencies over the individual links)). Further, it is seen that three paths are identified by respective dashed arrows. Each of these three paths is a potential path for routing a reference tunnel from R1 to R2. More particularly: Path_1 goes from R1 to R3 to R2; Path_2 goes from R1 to R4 to R2; Path_3 goes from R1 to R5 to R2.

Still referring to FIG. 2B, a further description including discussion of various specific example values will now be provided. As mentioned above, there is a network of five IP routers (R1, R2, R3, R4, R5) connected by six IP links (of course, any other desired number of routers and/or links can be utilized). In this example, each IP link has a total capacity of 100 Gbps and the latency in traversing the link in milliseconds is as shown. For the purposes of this example, the objective is to route a MPLS-TE tunnel from R1 to R2 (call this “reference tunnel”). There are three possible paths the reference tunnel can be routed over: (a) Path_1 is R1➔ R3 ➔R2 and has a total latency of 6 ms; (b) Path_2 is R1 ➔ R4 ➔ R2 and has a total latency of 10 ms; (c) Path_3 is R1 ➔ R5 ➔ R2 and has a total latency of 14 ms. In addition to the reference tunnel, there are other tunnels in the network that produce traffic over the IP links. These other tunnels are not identified individually in this figure but the total traffic produced by these other tunnels over a link can be referred to as “background traffic”. A routing goal according to an embodiment is to be able to route the reference tunnel over one or more paths to make sure that all of its traffic gets routed and if there are multiple choices then the path(s) with minimal latency are selected. In various examples, the path(s) that are selected can take into account the “background traffic”.

Still referring to FIG. 2B, a discussion of various dynamic split/merge scenario examples according to an embodiment will now be provided. More particularly:
Scenario 1 (initial): Reference tunnel bandwidth = 60 Gbps, Background traffic on every link is 5 Gbps
   In this case each of the 3 potential paths for routing the reference tunnel has 95 Gbps of available bandwidth. Therefore, the tunnel should not be split, and the entire tunnel should be routed over Path_1 with latency 6 ms.
Scenario 2: Reference tunnel bandwidth = 60 Gbps, Background traffic on every link increases to 50 Gbps
   In this case no single path can accommodate the entire reference tunnel bandwidth but each path can accommodate half the reference tunnel bandwidth. So, the reference tunnel should be split into two equal components and component 1 should be routed over Path_1 (latency = 6 ms) and component 2 should be routed over Path_2 (latency = 10 ms).
Scenario 3: Reference tunnel bandwidth = 60 Gbps, Background traffic on every link increases to 75 Gbps
   In this case no single path can accommodate the entire reference tunnel bandwidth but each path can accommodate one-third the reference tunnel bandwidth. So, the reference tunnel should be split into three equal components and component 1 should be routed over Path_1 (latency = 6 ms), component 2 should be routed over Path_2 (latency = 10 ms), and component 3 should be routed over Path_3 (latency = 14 ms).
Scenario 4: Reference tunnel bandwidth decreases to 35 Gbps, Background traffic on every link decreases to 50 Gbps
   In this case each of the 3 potential paths for routing the reference tunnel has 50 Gbps of available bandwidth. Therefore, the tunnel should not be split, and the entire tunnel should be routed over Path_1 with latency 6 ms.

Still referring to FIG. 2B, a discussion of certain benefits of a dynamic split/merge mechanism (according to an embodiment) over a static split/merge mechanism will now be provided. More particularly:
If a static policy is used, then the reference tunnel split/merge decision will not be taking into account the background traffic and the reference tunnel would always split (or merge) at the same threshold.
   In such a static case, in the event that a very high split threshold (e.g., 70 Gbps) is used, then the reference tunnel would not be split for any of the 4 scenarios described above. This will work OK for scenarios 1 and 4. However, for scenarios 2 and 3, there will not be enough bandwidth on the path and thereby traffic will be lost.
   Further, in such a static case, in the event that a low split threshold (e.g., 20 Gbps) is used, then there will not be any traffic loss in any of the scenarios. However, in scenarios 1 and 4, some of the components of the traffic may go on a path having longer latency than necessary.
In contrast, with the dynamic split/merge policy used by the SDN controller according to various embodiments, the network condition (e.g., background traffic) will be taken into account, to split traffic when necessary, and to send all traffic on a low-latency path (e.g., lowest-latency path) when possible.

Referring now to FIG. 2C, various steps of a method 2000 according to an embodiment are shown. As seen in this FIG. 2C, step 2001 comprises obtaining node data identifying a source node of a network and a destination node of the network, wherein the network comprises the source node, the destination node, and a plurality of other nodes. Next, step 2003 comprises obtaining reference path data identifying a reference path from the source node to the destination node. Next, step 2005 comprises obtaining alternate path data identifying a plurality of alternate paths from the source node to the destination node, wherein each of the plurality of alternate paths is different from the reference path. Next, step 2007 comprises setting for the reference path a possible split threshold, the possible split threshold identifying a traffic bandwidth which can trigger a re-direction of traffic from the reference path. Next, step 2009 comprises determining whether a current traffic flow on the reference path meets the possible split threshold, resulting in a first determination. Next, step 2011 comprises responsive to the first determination being that the current traffic flow on the reference path meets the possible split threshold, obtaining, subsequent to the setting for the reference path of the possible split threshold, current alternate path data for each of the plurality of alternate paths, wherein the current alternate path data comprises for each of the plurality of alternate paths a respective current alternate path bandwidth availability. Next, step 2013 comprises responsive to the obtaining of the current alternate path data for each of the plurality of alternate paths, determining whether a particular one of the plurality of alternate paths can support carrying of at least some of the current traffic flow on the reference path, resulting in a second determination, wherein the second determination is based at least in part upon the current alternate path bandwidth availability of each of the plurality of alternate paths. Next, step 2015 comprises responsive to the second determination being that the particular one of the plurality of alternate paths can support the carrying of at least some of the current traffic flow on the reference path, re-directing a portion of the current traffic flow from the reference path to the particular one of the alterative paths.

While for purposes of simplicity of explanation, the respective processes are shown and described as a series of blocks in 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2D, various steps of a method 2100 according to an embodiment are shown. As seen in this FIG. 2D, step 2101 comprises obtaining network data indicative of a network comprising a source router, a destination router, and a plurality of other routers. Next, step 2103 comprises obtaining reference path data indicative of a reference path from the source router to the destination router. Next, step 2105 comprises setting for the reference path a possible split threshold, the possible split threshold identifying a traffic bandwidth which can trigger a directing of traffic from the reference path to another path. Next, step 2107 comprises obtaining, subsequent to the setting for the reference path of the possible split threshold, alternate path data indicative of a plurality of alternate paths from the source router to the destination router, wherein each of the plurality of alternate paths is different from the reference path, wherein the alternate path data identifies for each of the plurality of alternate paths respective current alternate path bandwidth capacity, and wherein the alternate path data identifies for each of the plurality of alternate paths respective current alternative path latency. Next, step 2109 comprises determining whether a current traffic flow that is being carried on the reference path is at or above the possible split threshold, resulting in a first determination. Next, step 2111 comprises responsive to the first determination being that the current traffic flow that is being carried on the reference path is at or above the possible split threshold, determining whether two or more particular ones of the plurality of alternate paths can support carrying some of the current traffic flow that is being carried on the reference path, resulting in a second determination, wherein the second determination is based at least in part upon the current alternate path bandwidth capacity for each alternate path. Next, step 2113 comprises responsive to the second determination being that the two or more particular ones of the plurality of alternate paths can support carrying of some of the current traffic flow that is being carried on the reference path, determining which of the two or more particular ones of the plurality of alternate paths that can support carrying of some of the current traffic flow that is being carried on the reference path has a lower latency, resulting in a third determination, wherein the third determination is based at least in part upon the current alternate path bandwidth latency for each alternate path. Next, step 2115 comprises responsive to the third determination as to which of the two or more particular ones of the plurality of alternate paths that can support carrying of some of the current traffic flow that is being carried on the reference path has the lower latency, directing the some of the current traffic flow from the reference path to the particular one of the alternate paths that has the lower latency.

While for purposes of simplicity of explanation, the respective processes are shown and described as a series of blocks in 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2E, various steps of a method 2200 according to an embodiment are shown. As seen in this FIG. 2E, step 2201 comprises obtaining, by a processing system including a processor, network data indicative of an Internet Protocol (IP) network comprising a source router, a destination router, and a plurality of other routers. Next, step 2203 comprises obtaining, by the processing system, first path data indicative of a first path from the source router to the destination router. Next, step 2205 comprises setting, by the processing system, for the first path a possible split threshold, the possible split threshold identifying a traffic bandwidth which can trigger a re-directing of a portion of traffic from the first path to one or more other paths. Next, step 2207 comprises obtaining by the processing system, subsequent to the setting for the first path of the possible split threshold, alternate path data indicative of a plurality of alternate paths from the source router to the destination router, wherein each of the plurality of alternate paths is different from the first path, wherein the alternate path data identifies for each of the plurality of alternate paths respective current alternate path bandwidth capacity, and wherein the alternate path data identifies for each of the plurality of alternate paths respective current alternate path latency. Next, step 2209 comprises determining, by the processing system, whether a current traffic flow that is being carried via the first path is at or above the possible split threshold. Next, step 2211 comprises responsive to determining that the current traffic flow is at or above the possible split threshold, determining by the processing system whether each of three or more candidate paths of the plurality of alternate paths can support carrying of at least some of the current traffic flow that is being carried on the first path, wherein the determining whether each of the three or more candidate paths can support carrying of at least some of the current traffic flow that is being carried on the first path is based at least in part upon the current alternate path bandwidth capacity for each alternate path. Next, step 2213 comprises responsive to determining that each of the three or more candidate paths can support carrying of at least some of the current traffic flow that is being carried on the first path, determining by the processing system a subset of the three or more candidate paths, wherein the subset comprises at least two paths, and wherein each of the at least two paths has a latency less than that of at least one of the other ones of the three or more candidate paths. Next, step 2215 comprises responsive to the determining the subset, directing by the processing system a first portion of the current traffic flow from the first path to a first one of the paths of the subset and directing a second portion of the current traffic flow from the first path to a second one of the paths of the subset.

While for purposes of simplicity of explanation, the respective processes are shown and described as a series of blocks in 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, benefits of various embodiments related to splitting and/or merging of tunnels can include: (a) Better bin packing to improve network utilization and avoid congestion; (b) Improved network survivability; (c) Less bandwidth required for preemption events; and/or (d) Evolution from router-based tunnel management to SDN-based control.

As described herein, various embodiments can provide for the dynamic creation and/or deletion of tunnels.

As described herein, various embodiments can provide a mechanism that is implemented in the context of traffic engineering of MPLS tunnels for interconnecting different network nodes within an IGP (Interior Gateway Protocol) network. The MPLS tunnels can be LSPs (label switched paths) which reserve resources using the RSVP protocol (Resource Reservation Protocol).

As described herein, various embodiments can facilitate benefits that are provided by automated centralized management of traffic flow (by a centralized controller), thus removing (in one example) any need for manual configuration of the network. In one example, this algorithmic automation enables efficient bin packing. In another example, this algorithmic automation uses a globally optimized algorithm based on global knowledge of network state not available to individual distributed routers.

As described herein, various embodiments can facilitate benefits that include reduced operational resources to manage and monitor the network and to handle the dynamic traffic changes in the network.

As described herein, in various embodiments “possible split threshold” and “possible merge threshold” parameters are set by an SDN controller (the parameters can be tunnel specific or the same for all tunnels). When a tunnel bandwidth exceeds the “possible split threshold” (e.g., 75 Gbps) the SDN controller algorithm does an optimization analysis to determine if there is a benefit to splitting. If there is a benefit, then the tunnel is split into multiple tunnels where each of the multiple tunnels from the same source and destination can, for example, share the traffic equally (the traffic can take different paths without causing congestion on any link bundle and thus avoiding traffic loss). When a set of tunnels (e.g., that were part of a previously split tunnel) have their bandwidth go below the “possible merge threshold” (e.g., 30 Gbps) the SDN controller algorithm does an optimization analysis to determine if there is a benefit to merging. If there is a benefit, then the tunnels are merged into one (or otherwise fewer) tunnels. This avoids the network having too many tunnels and thus conserving resources.

As described herein, various embodiments can operate in the context of an IP network with a large number of tunnels (e.g. 5,000 to 10,000 tunnels).

As described herein, various embodiments can provide for splitting a large tunnel into smaller tunnels when the network conditions are advantageous for such splitting.

As described herein, various embodiments can provide for avoiding splitting of a smaller tunnel when network conditions are advantageous for avoidance of such splitting.

As described herein, various embodiments can provide for dynamic, real-time splitting and/or merging. In various embodiments, a decision to split or merge can be made based upon a centralized global view that takes into account information from a plurality of routers (e.g., all routers) in a network.

As described herein, various embodiments can provide for dynamic, real-time splitting and/or merging taking into account one or more priority classes for traffic that is being carried on the network.

As described herein, various embodiments can provide for a centralized controller that can implement dynamic routing changes depending upon network events and/or the time of day.

As described herein, various embodiments can provide for a centralized controller that can implement dynamic routing changes depending upon geographic location (e.g., split a tunnel between New York and San Francisco into two parts, wherein one part can go through the northern half of the country and the other part can go through the southern half of the country).

As described herein, various embodiments can provide for a centralized controller that can implement dynamic routing changes by taking into account real-time network conditions.

As described herein, various embodiments can provide for a centralized controller that can implement automatic dynamic routing changes (thus avoiding the need for certain manual configuration).

As described herein, various embodiments can provide for a centralized controller that can place a limit (e.g., an upper limit) on the number of tunnels.

As described herein, various embodiments can provide for a centralized controller that can place a limit (e.g., a lower limit) on the number of tunnels.

As described herein, various embodiments can provide for a centralized controller that can make a splitting decision based upon a first threshold value at one time and based upon another (different) threshold value at another (different) time (the decisions can be based upon, for example, network conditions at the different times).

As described herein, various embodiments can provide for a centralized controller that can make a merging decision based upon a first threshold value at one time and based upon another (different) threshold value at another (different) time (the decisions can be based upon, for example, network conditions at the different times).

As described herein, various embodiments can provide for a centralized controller that can route traffic based upon one or more priority classes (e.g., high priority traffic vs low priority traffic).

As described herein, various embodiments can provide for a centralized controller that can route traffic based upon probability of what tunnel size can be fit in view of a current bandwidth scenario in the whole (global) network being operated on.

As described herein, various embodiments can provide for splitting that can be into two paths or into more than two paths.

As described herein, various embodiments can provide for merging that can be from two paths or from more than two paths.

As described herein, various embodiments can provide for splitting into equal parts or into unequal parts. In one example related to equal bandwidth parts, each tunnel will have the same bandwidth as the aggregate bandwidth of all the splits divided by the number of splits.

As described herein, various embodiments can provide for adjusting of thresholds (e.g., adjusting of possible split threshold and/or adjusting of possible merge threshold). In one example, adjusting of split/merge thresholds can be done globally (network wide) or per tunnel, based on the historical traffic profile on the tunnel. The split/merge thresholds can be configured such that tunnels are not repeatedly split then merged based on small traffic changes (these thresholds can be the tunnel signal bandwidth limits at which algorithm may decide to split or merge). In one specific example: When the link capacities are about a few hundred gbps to tbps, and tunnel’s traffic occasionally reaching 100gbps, it does not make sense to put the split threshold to 10gbps (in this case, an upper threshold of, e.g., 70gbps may be reasonable). Similarly, when the tunnel is split the merge threshold can be set not too close that the split and merge occurs with minor traffic changes.

As described herein, various embodiments can provide for taking into account (e.g., when making a new split decision and/or when making a new merge decision) any prior splitting and/or any prior merging. In one example, if a tunnel traffic is frequently fluctuating and breaching the split and merge thresholds, the algorithm would keep a check and not change as frequently (in one example, the algorithm would recheck the stability of the tunnel after a certain time (e.g., after a certain amount of time)). In one specific example, when making a new split decision and/or a new merge decision, a path that was only recently split may not be merged for X amount of time (e.g., about 5-10 minutes).

As described herein, various embodiments can provide for splitting that can be predictive, carried out via artificial intelligence (AI), based upon historical data, or any combination thereof. In one example, based on forecasted traffic on the tunnel(s) and the timings, the split can be done ahead of time even before the actual signal traffic breaches the threshold(s).

As described herein, various embodiments can provide for merging that can be predictive, carried out via artificial intelligence (AI), based upon historical data, or any combination thereof. In one example, based on forecasted traffic on the tunnel(s) and the timings, the merge can be done ahead of time even before the actual signal traffic breaches the threshold(s).

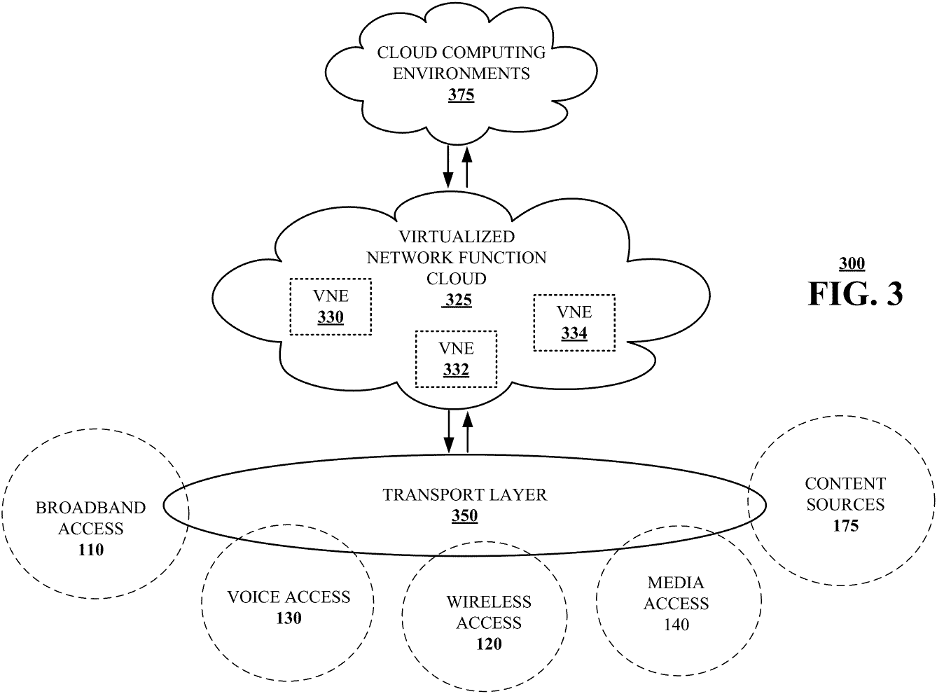

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, some or all of the subsystems and functions of system 200, some or all of the subsystems and functions of system 250, and/or some or all of the functions of methods 2000, 2100, and/or 2200. For example, virtualized communication network 300 can facilitate in whole or in part dynamic tunnel splitting/merging using a centralized controller.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it’s elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don’t typically need to forward large amounts of traffic, their workload can be distributed across a number of servers - each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

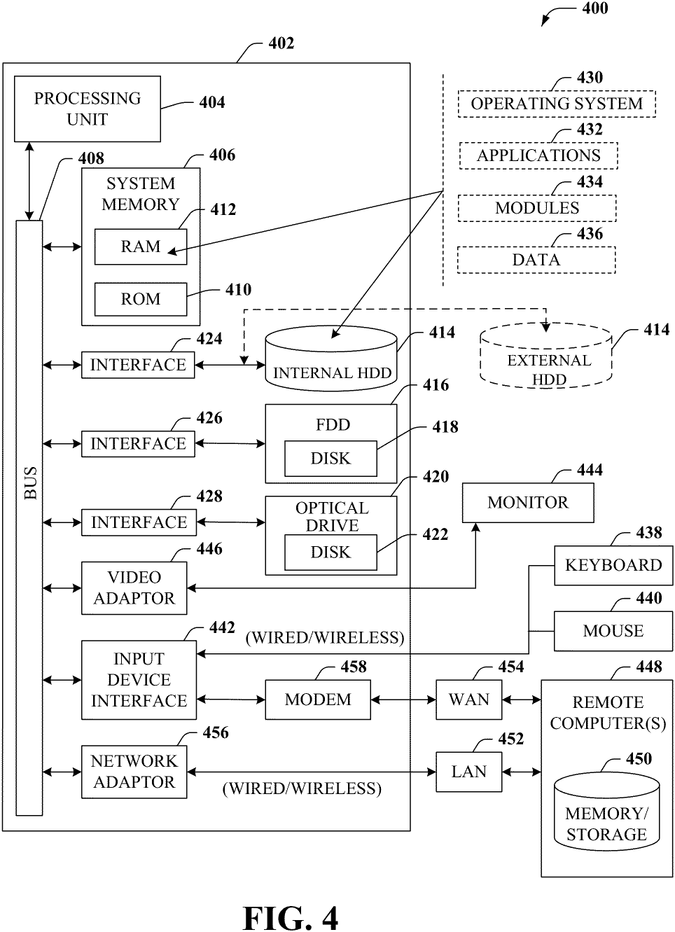

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part dynamic tunnel splitting/merging using a centralized controller.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

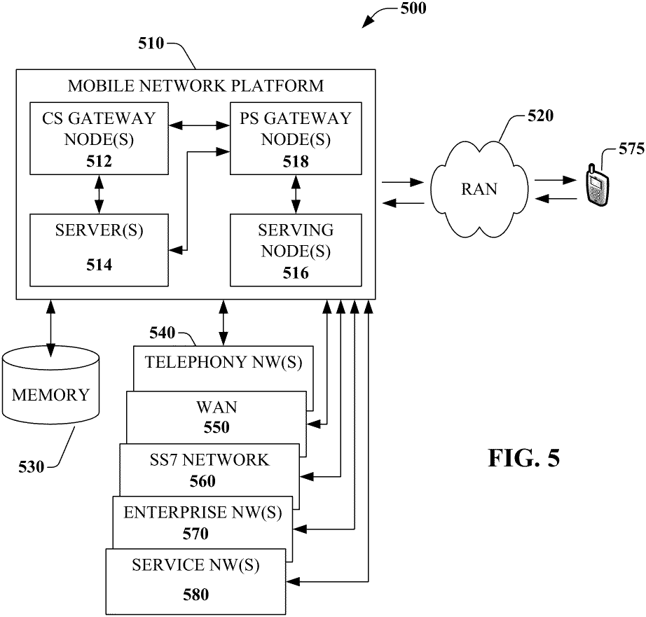

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part dynamic tunnel splitting/merging using a centralized controller. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format ...) such flows. Such application(s) can comprise add-on features to standard services (for example, provisioning, billing, customer support ...) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network’s operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

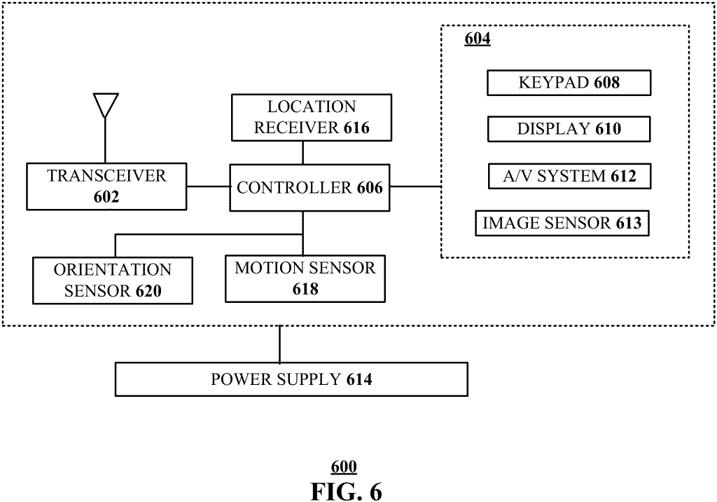

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part dynamic tunnel splitting/merging using a centralized controller.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth^{®}, ZigBee^{®}, WiFi, DECT, or cellular communication technologies, just to mention a few (Bluetooth^{®} and ZigBee^{®} are trademarks registered by the Bluetooth^{®} Special Interest Group and the ZigBee^{®} Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth^{®}. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user’s finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth^{®}, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn’t otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically performing dynamic tunnel splitting/merging using a centralized controller) can employ various AI-based schemes for carrying out various embodiments thereof. Moreover, the classifier can be employed to determine a ranking or priority of each tunnel and/or each network node. A classifier is a function that maps an input attribute vector, x = (x1, x2, x3, x4, ..., xn), to a confidence that the input belongs to a class, that is, f(x) = confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the tunnels and/or network nodes will receive priority, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” ”subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” “data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
obtaining node data identifying a source node of a network and a destination node of the network, wherein the network comprises the source node, the destination node, and a plurality of other nodes;
obtaining reference path data identifying a reference path from the source node to the destination node;
obtaining alternate path data identifying a plurality of alternate paths from the source node to the destination node, wherein each of the plurality of alternate paths is different from the reference path;
setting for the reference path a possible split threshold, the possible split threshold identifying a traffic bandwidth which can trigger a re-direction of traffic from the reference path;
determining whether a current traffic flow on the reference path meets the possible split threshold, resulting in a first determination;
responsive to the first determination being that the current traffic flow on the reference path meets the possible split threshold, obtaining, subsequent to the setting for the reference path of the possible split threshold, current alternate path data for each of the plurality of alternate paths, wherein the current alternate path data comprises for each of the plurality of alternate paths a respective current alternate path bandwidth availability;
responsive to the obtaining of the current alternate path data for each of the plurality of alternate paths, determining whether a particular one of the plurality of alternate paths can support carrying of at least some of the current traffic flow on the reference path, resulting in a second determination, wherein the second determination is based at least in part upon the current alternate path bandwidth availability of each of the plurality of alternate paths; and
responsive to the second determination being that the particular one of the plurality of alternate paths can support the carrying of at least some of the current traffic flow on the reference path, re-directing a portion of the current traffic flow from the reference path to the particular one of the alterative paths.

2. The device of claim 1, wherein:
the source node comprises a first router;
the destination node comprises a second router; and
each of the plurality of other nodes comprises a respective router.

3. The device of claim 1, wherein:
the network comprises an Internet Protocol (IP) network;
the source node is connected by a respective IP link to either the destination node or to one of the plurality of other nodes;
the destination node is connected by a respective IP link to either the source node or to one of the plurality of other nodes; and
each of the plurality of other nodes is connected by a respective IP link to one of the plurality of other nodes, to the source node, or to the destination node.

4. The device of claim 1, wherein the reference path is an Internet Protocol (IP) link between the source node and the destination node.

5. The device of claim 1, wherein the reference path comprises:
a first Internet Protocol (IP) link between the source node and at least one of the plurality of other nodes; and
a second IP link between the at least one of the plurality of other nodes and the destination node.

6. The device of claim 1, wherein:
the device comprises a centralized system;
the centralized system receives first data indicative of the current traffic flow on the reference path;
the first data is received from the source node, the destination node, or any combination thereof; and
the centralized system receives a respective part of the current alternate path data from the source node, the destination node, one or more of the plurality of other nodes, or any combination thereof.

7. The device of claim 1, wherein the obtaining the current alternate path data for each of the plurality of alternate paths is performed in real-time.

8. The device of claim 1, wherein the determining whether the particular one of the plurality of alternate paths can support carrying of at least some of the current traffic flow on the reference path comprises selecting the particular one of the plurality of alternate paths from among two or more candidate alternate paths that can support carrying of at least some of the current traffic flow.

9. The device of claim 8, wherein the selecting the particular one of the plurality of alternate paths from among the two or more candidate alternate paths comprises selecting the particular one of the plurality of alternate paths based upon the particular one of the plurality of alternate paths having a current latency that is less than each of the other candidate alternate paths.

10. The device of claim 1, wherein the re-directing comprises sending instructions to the source node, the destination node, one or more of the plurality of other nodes, or any combination thereof.

11. The device of claim 10, wherein the re-directing is performed in real-time.

12. The device of claim 1, wherein the determining whether the current traffic flow on the reference path meets the possible split threshold comprises determining whether the current traffic flow on the reference path is at or above the possible split threshold.

13. The device of claim 1, wherein:
the node data is obtained from a first database;
the reference path data is obtained from a second database; and
the alternate path data is obtained from a third database.

14. The device of claim 13, wherein each of the first database, the second database, and the third database is a same database.

15. A non-transitory machine-readable medium comprising executable instructions that, when executed by a processing system including a processor, facilitate performance of operations, the operations comprising:
obtaining network data indicative of a network comprising a source router, a destination router, and a plurality of other routers;
obtaining reference path data indicative of a reference path from the source router to the destination router;
setting for the reference path a possible split threshold, the possible split threshold identifying a traffic bandwidth which can trigger a directing of traffic from the reference path to another path;
obtaining, subsequent to the setting for the reference path of the possible split threshold, alternate path data indicative of a plurality of alternate paths from the source router to the destination router, wherein each of the plurality of alternate paths is different from the reference path, wherein the alternate path data identifies for each of the plurality of alternate paths respective current alternate path bandwidth capacity, and wherein the alternate path data identifies for each of the plurality of alternate paths respective current alternative path latency;
determining whether a current traffic flow that is being carried on the reference path is at or above the possible split threshold, resulting in a first determination;
responsive to the first determination being that the current traffic flow that is being carried on the reference path is at or above the possible split threshold, determining whether two or more particular ones of the plurality of alternate paths can support carrying some of the current traffic flow that is being carried on the reference path, resulting in a second determination, wherein the second determination is based at least in part upon the current alternate path bandwidth capacity for each alternate path;
responsive to the second determination being that the two or more particular ones of the plurality of alternate paths can support carrying of some of the current traffic flow that is being carried on the reference path, determining which of the two or more particular ones of the plurality of alternate paths that can support carrying of some of the current traffic flow that is being carried on the reference path has a lower latency, resulting in a third determination, wherein the third determination is based at least in part upon the current alternate path latency for each alternate path; and
responsive to the third determination as to which of the two or more particular ones of the plurality of alternate paths that can support carrying of some of the current traffic flow that is being carried on the reference path has the lower latency, directing the some of the current traffic flow from the reference path to the particular one of the alternate paths that has the lower latency.

16. The non-transitory machine-readable medium of claim 15, wherein the operations further comprise:
subsequent to the directing of the some of the current traffic flow from the reference path to the particular one of the alternate paths that has the lower latency, re-directing traffic flow back to the reference path.

17. The non-transitory machine-readable medium of claim 16, wherein the re-directing is responsive to a current bandwidth availability of the reference path, a current latency of the reference path, or any combination thereof.

18. The non-transitory machine-readable medium of claim 15, wherein:
the network is an Internet Protocol (IP) network; and
the directing comprises sending instructions to the source router, the destination router, one or more of the plurality of other routers, or any combination thereof.

19. A method comprising:
obtaining, by a processing system including a processor, network data indicative of an Internet Protocol (IP) network comprising a source router, a destination router, and a plurality of other routers;
obtaining, by the processing system, first path data indicative of a first path from the source router to the destination router;
setting, by the processing system, for the first path a possible split threshold, the possible split threshold identifying a traffic bandwidth which can trigger a re-directing of a portion of traffic from the first path to one or more other paths;
obtaining by the processing system, subsequent to the setting for the first path of the possible split threshold, alternate path data indicative of a plurality of alternate paths from the source router to the destination router, wherein each of the plurality of alternate paths is different from the first path, wherein the alternate path data identifies for each of the plurality of alternate paths respective current alternate path bandwidth capacity, and wherein the alternate path data identifies for each of the plurality of alternate paths respective current alternate path latency;
determining, by the processing system, whether a current traffic flow that is being carried via the first path is at or above the possible split threshold;
responsive to determining that the current traffic flow is at or above the possible split threshold, determining by the processing system whether each of three or more candidate paths of the plurality of alternate paths can support carrying of at least some of the current traffic flow that is being carried on the first path, wherein the determining whether each of the three or more candidate paths can support carrying of at least some of the current traffic flow that is being carried on the first path is based at least in part upon the current alternate path bandwidth capacity for each alternate path;
responsive to determining that each of the three or more candidate paths can support carrying of at least some of the current traffic flow that is being carried on the first path, determining by the processing system a subset of the three or more candidate paths, wherein the subset comprises at least two paths, and wherein each of the at least two paths has a latency less than that of at least one of the other ones of the three or more candidate paths; and
responsive to the determining the subset, directing by the processing system a first portion of the current traffic flow from the first path to a first one of the paths of the subset and directing a second portion of the current traffic flow from the first path to a second one of the paths of the subset.

20. The method of claim 19, wherein the first portion and the second portion comprise a same amount of traffic.
